(19) United States
(12) Patent Application Publication
(10) Pub. No.: US 2021/0117887 A1
(43) Pub. Date: Apr. 22, 2021

(54) METHODS AND SYSTEMS FOR FARMING TASK MANAGEMENT

(71) Applicant: Tycom, Inc., Raleigh, NC (US)

(72) Inventor: Tyler McGee, Raleigh, NC (US)

(21) Appl. No.: 16/660,424

(22) Filed: Oct. 22, 2019

(51) Int. Cl. G06Q 10/06; G06N 5/04; G06Q 20/30

(52) U.S. Cl. CPC G06Q 10/06311; G06Q 20/305; G06N 5/04

(57) ABSTRACT

Farm task management systems provide farms with the ability to manage farm tasks by creating representations of farm tasks within the system where the representation includes attributes of the task that are linked together. One attribute specifies a doer that is being assigned the task and the farm task management system notifies the doer about the task including the attributes of the task that are linked together to provide the doer with the information necessary to complete the farm task. The farm management system may track whether tasks have been accepted or declined and whether the tasks are pending or completed. The farm management system may initiate payment for the completion of a task. The farm management system may also employ weather intelligence to assist in creating the task and choosing a date or date range for task completion.

### TECHNICAL FIELD

Embodiments relate to methods and systems used for management of tasks that are performed on farms.

### BACKGROUND

Farming requires that a significant number of tasks be performed in a timely manner in order to operate effectively and efficiently. The performance of these tasks ensures that a satisfactory yield of crops from one or more fields is achieved. Often, farm owners or managers utilize a distributed work force to handle these tasks. This is particularly the case as the size of farms increase, with some farms having many separate fields, each potentially having its own set of tasks to be performed and on a particular schedule.

With a distributed workforce handling these tasks for the various fields of a farm, keeping track of the tasks to be done for each field and whether they have been completed becomes a significant challenge for farm owners or managers. Furthermore, communicating with the distributed workforce in an efficient manner in order to facilitate the timely completion of the various tasks for the various fields and on the appropriate schedule further complicates the farm management.

### SUMMARY

Embodiments address issues such as these and others by providing methods and farm management systems that provide for assigning tasks to a farm workforce. Assigning the tasks can involve the person assigning the task interacting with a user interface of the system to provide the necessary attributes for the task. The system may then create an association of the attributes to the task and then distribute the task to an account of a selected doer, i.e., a specific worker or pool of workers, that is maintained by the system. The doer may then obtain the attributes of the task from the system through a user interface of the system and proceed to complete the task. The doer may then interact with the user interface of the system to indicate that the task has been completed, and the system may then reflect that the task is completed. Additional features may also be provided, such as the system initiating a payment to the doer upon completion of the task. Furthermore, the system may utilize intelligence to guide the creation of the task, such as by monitoring weather forecast data and suggesting alternative dates for the task.

Embodiments provide systems and methods of assigning tasks to a farming workforce, that involve providing a user interface with a set of attribute input interface fields that comprise a farm field interface field, an activity type interface field, and a doer interface field. The embodiments involve providing farm field assets for selection for the farm field interface field, providing activity type assets for selection for the activity type interface field, and providing doer assets for selection for the doer interface field. The embodiments further involve receiving into the farm field interface field a farm field asset selection from the farm field assets, receiving into the activity type interface field an activity type asset selection from the activity type assets, and receiving into the doer interface field a doer asset selection from the doer assets. Embodiments further involve creating an association of the received farm field asset selection, the received activity type asset selection, and the received doer asset selection. The association has a completion state value that represents that a task represented by the association has been completed or deleted. The embodiments also involve providing a message regarding the task to an account of the doer asset selection, the message indicating the received farm field asset selection and received activity type asset selection. The embodiments involve receiving from the account of the doer asset an indication regarding the task, the indication specifying that the task has been completed or deleted, and involve changing the completion state value to represent that the task has been completed or deleted.

Embodiments also provide systems and methods of assigning tasks to a farming workforce, that involve providing a user interface with a set of attribute input interface fields that comprise a farm field interface field, an activity type interface field, a doer interface field, and a date interface field. The embodiments involve providing farm field assets for selection for the farm field interface field, providing activity type assets for selection for the activity type interface field, providing doer assets for selection for the doer interface field, and providing date assets for selection for the date interface field. The embodiments involve receiving into the farm field interface field a farm field asset selection from the farm field assets, receiving into the activity type interface field an activity type asset selection from the activity type assets, receiving into the doer interface field a doer asset selection from the doer assets, and receiving into the date interface field a date asset selection from the date assets. The embodiments involve creating an association of the received farm field asset selection, the received activity type asset selection, the received doer asset selection, and the received date asset selection. The embodiments further involve performing a look-up of the date asset in a precipitation prediction database. The embodiments provide that when the precipitation prediction database shows a precipitation prediction that exceeds a threshold for the date asset, then providing an indication within the user interface about the precipitation prediction for the data asset and providing an alternate date asset for selection. The embodiments further provide that when the alternate date asset is selected, then replacing the date asset selection with the alternate date asset selection within the association. The embodiments further involve providing a message regarding the task to an account of the doer asset selection, the message indicating the received farm field asset selection, the received activity type asset selection, and the received data asset selection or the alternate date asset selection.

Embodiments provide systems and methods of assigning tasks to a farming workforce. The embodiments involve providing a user interface with a set of attribute input interface fields that comprise a farm field interface field, an activity type interface field, and a doer interface field, providing farm field assets for selection for the farm field interface field, providing activity type assets for selection for the activity type interface field, and providing doer assets for selection for the doer interface field. The embodiments involve receiving into the farm field interface field a farm field asset selection from the farm field assets, receiving into the activity type interface field an activity type asset selection from the activity type assets, and receiving into the doer interface field a doer asset selection from the doer assets. The embodiments involve creating a task object by providing associative linking of the received farm field asset selection, the received activity type asset selection, and the received doer asset selection. The task object thereby provides a data model that is a flat non-hierarchy of the received farm field asset selection, the received activity type asset selection, and the received doer asset selection to avoid hierarchy. The embodiments further involve providing a message regarding the task object to an account of the doer asset selection, the message indicating the received farm field asset selection and received activity type asset selection.

### DESCRIPTION OF THE DRAWINGS

FIG. 1 shows an example of a farm operating environment for various embodiments disclosed herein.

FIG. 2A shows an example of a system configuration for the embodiments.

FIG. 2B shows an example of an organizational configuration of an account managed within the system of the various embodiments.

FIG. 2C shows an example of associate linking of task attributes for a task object that forms a flat, non-hierarchical data model.

FIG. 3A shows a first portion of a first example of an operational flow of the system of the various embodiments.

FIG. 3B shows a second portion of the first example of the operational flow of the system of the various embodiments.

FIG. 4 shows an alternative operational flow of the various embodiments that implements weather intelligence to assist in creating the task.

FIG. 5A is an example of a screenshot of a today page of a graphical user interface that may be viewed by someone to see existing tasks or to create a new task in the system.

FIG. 5B is an example of a screenshot of a new task page of a graphical user interface that may be viewed by someone to create a new task in the system.

FIG. 5C is an example of a screenshot that shows the new task page when selecting a field attribute of the new task.

FIG. 5D shows the new task page when selecting an activity attribute of the new task.

FIG. 5E is an example of a screenshot that shows the new task page when selecting a doer attribute of the new task.

FIG. 5F is an example of a screenshot that shows the new task page when selecting a machine attribute of the new task.

FIG. 5G is an example of a screenshot that shows the new task page when selecting a start and end date attributes of the new task.

FIG. 5H is an example of a screenshot that shows a review task page for reviewing the selected attributes of the new task that is being created.

FIG. 5I is an example of a screenshot that shows a task detail page that allows the task creator to provide additional details for the specific activity that has been chosen for the new task.

FIG. 5Ia is an example of a screenshot that shows an alternate task detail page that allows the task creator to provide additional details for the specific activity that has been chosen for the new task as well as proceed to attach payment to the new task.

FIG. 5Ib is an example of a screenshot that shows a payment information display that allows the task creator to provide additional details for the payment that will be provided to the doer for completion of the new task.

FIG. 5J is an example of a screenshot that shows a weather check display and alternative options related to selected start and/or end dates for the new task.

FIG. 6A is an example of a screenshot that shows a notification on the lock screen of a mobile device of a doer who has been assigned the new task.

FIG. 6B is an example of a screenshot that shows a message in the inbox of a system account of the doer who has been assigned the new task.

FIG. 6C is an example of a screenshot that shows an accept and decline option for the new task within the inbox of the system account of the doer.

FIG. 7 is an example of a screenshot that shows a notification on the lock screen of a mobile device of the task creator indicating that the selected doer for the new task has accepted the new task.

FIG. 8A is an example of a screenshot of a today page of a graphical user interface that may be viewed by the doer to see tasks accepted by the doer, including the new task in the system.

FIG. 8B is an example of a screenshot of the today page of the graphical user interface that may be viewed by the doer to indicate that the accepted task has been declined or completed.

FIG. 9 is an example of a screenshot that shows a notification on the lock screen of the mobile device of the task creator indicating that the selected doer for the new task has completed the new task.

FIG. 10A is an example of a screenshot of a plan page of the graphical user interface that allows a task creator or doer to select a field or other area to review what tasks of the selected field have been declined, completed, or pending completion.

FIG. 10B is an example of a screenshot of a plan page of the graphical user interface that allows a task creator or doer to see activity types of the selected field and select an activity to review what tasks of the selected field and activity have been declined, completed, or pending completion.

FIG. 10C is an example of a screenshot of the plan page of the graphical user interface that shows a task creator or doer the selected a field or other area and selected activity type tasks that have been declined, completed, or pending completion while allowing for individual tasks to be deleted.

### DETAILED DESCRIPTION

Embodiments provide a system that allows for creation and management of farm tasks. Tasks, which may be represented within the system as tasks objects that are flat and non-hierarchical, may be created via a graphical user interface. The graphical user interface may provide various attribute interface fields may receive corresponding attribute selections from the task creator. The system may then keep track of the various tasks that have been created including acceptance or denial of the task, as well as completion states for accepted tasks, and may also provide corresponding task management information to users including task creators and doers. A manner of payment may also be attached to the task to provide for payment of the doer once completion of the task has occurred. Additionally, weather intelligence may be provided during task creation to suggest alternate dates for the task when appropriate based on weather forecast data.

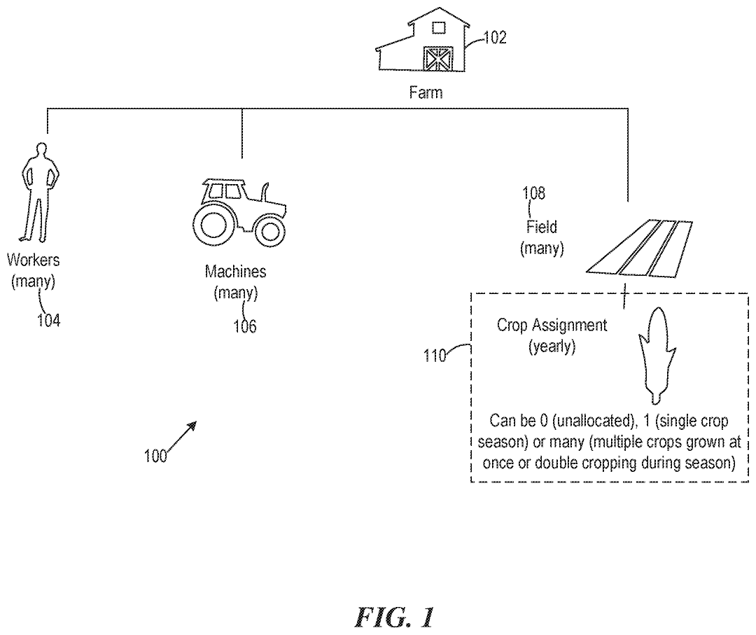

FIG. 1 shows an example of a farm organization 100 where a given farm 102 includes a collection of workers referred to as doers 104 that are assigned tasks to be completed. The farm 102 includes a collection of machines 106 that are used by the doers 104 when completing the tasks. Examples of the machines 106 include tractors, trucks, harvesters, and so forth. The farm also includes one or more fields 108 where the farming tasks are to be performed. Each field 108 may have at least one crop 110 assigned to it. Thus, a given farm task may involve a doer using a particular machine or machines to perform a particular farming activity for a particular crop within a particular field.

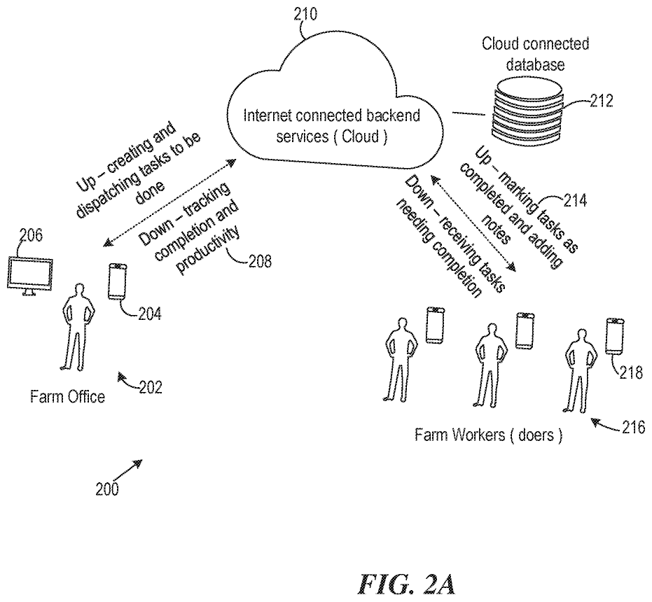

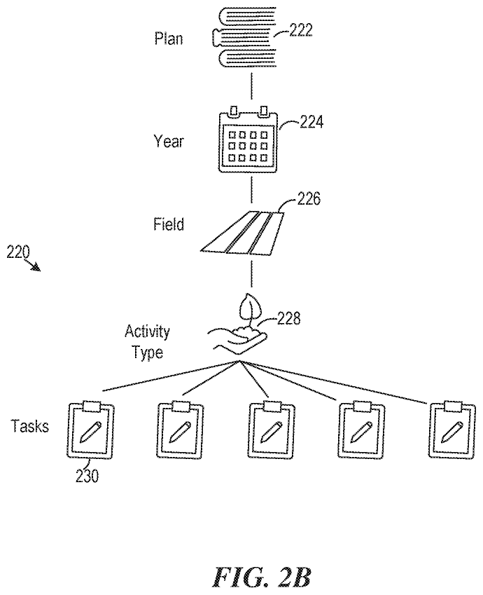

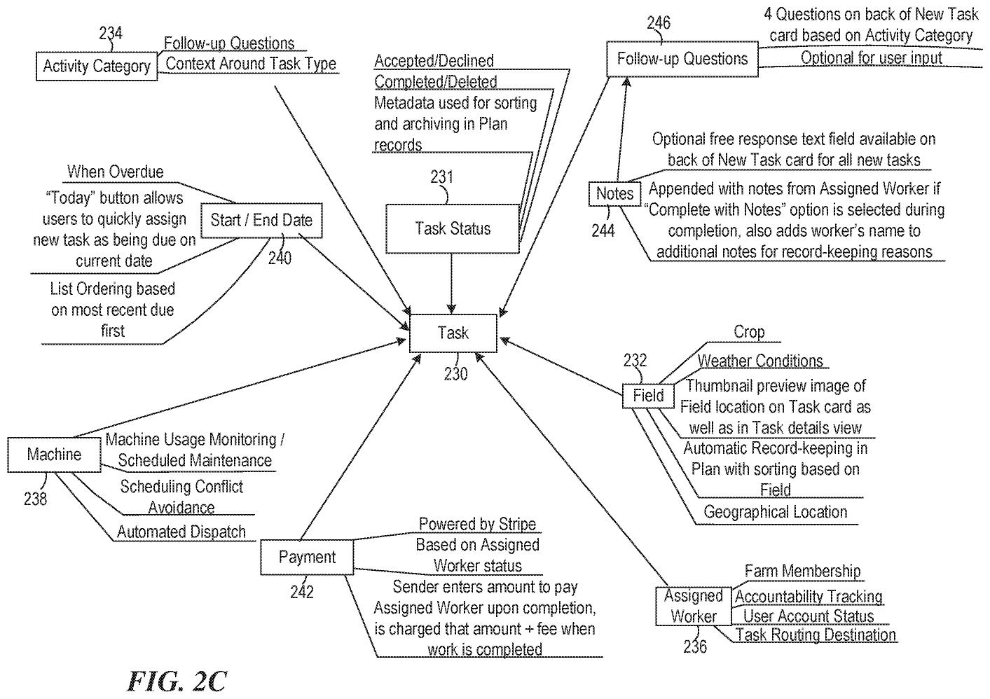

To allow personnel, such as the owner of a farm or a designated manager, to manage the completion of the farming tasks, embodiments of a system 200 as shown in FIG. 2A are provided. The system 200 may include a backend system 210 that provides various services for managing the creation and completion of the tasks including data keeping, management logic for producing notifications based on user activity, time, and other factors.

The backend system 210 may be a collection of one or more computer servers connected to a computer network such as the Internet where these one or more computer servers execute one or more programs for providing the services described herein. While the backend system 210 is described as being a collection of one or more computer servers, it will be appreciated that the backend system 210 may be provided in various forms, such as one or more conventional general purpose programmable computer systems, application specific devices, hard-wired digital logic, or any combination.

The backend system 210 may have access to a cloud connected database 212 that maintains the data for each farm that is being managed via the system 200. The cloud connected database 212 is provided via cloud based storage devices that are accessible by the back end system 210 when performing management logic and when providing information to user devices as described below.

From a management perspective, a given farm 102 includes what may be referred to as a farm office that includes all of the system user accounts 202 and associated devices that management personnel of the farm 102 may use to access the farm management services being provided by the backend system 210. Thus, the farm office 202 may include fixed computers 206 as well as mobile devices 204 such as smartphones used by management personnel to access their system user accounts 204 and thereby access the backend system 210. These farm office devices 204, 206 access the backend system 210 either via a dedicated application program being executed on the device 204, 206, or in some embodiments through a general purpose web browser application being executed on the device 204, 206. In either case, the device 204, 206 utilizes a bi-directional network connection 208 such as a cellular data network or Wi-Fi hotspot. The devices 204, 206 upload data for creating tasks and download data related to tracking the completion of tasks and general productivity for the farm 102.

For a given farm 102, the backend system 210 also maintains system user accounts 216 for doers 104 using associated devices to access the farm management services being provided by the backend system 210. These devices 218 may include fixed computers as well as mobile devices such as smartphones, although mobile devices such as smartphones are more practical for doers 104 who are typically in the fields 108 performing tasks or in transit to and from the fields 108. These doer devices 218 also access the backend system 210 either via a dedicated application program being executed on the devices 218 or in some embodiments through a general purpose web browser application being executed on the device 218. In either case, the device 218 utilizes a bi-directional network connection 214 such as a cellular data network or Wi-Fi hotspot. The device 218 uploads data for marking tasks as accepted or denied, as well as completed and can also add notes. The device 218 downloads data related to receiving assigned tasks and related notifications.

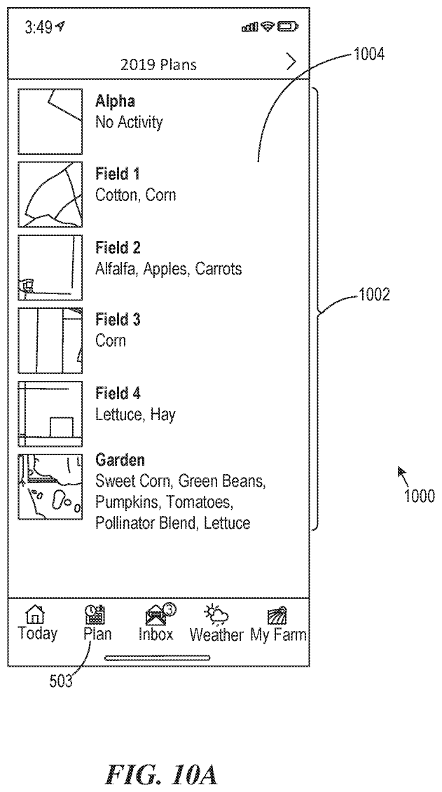

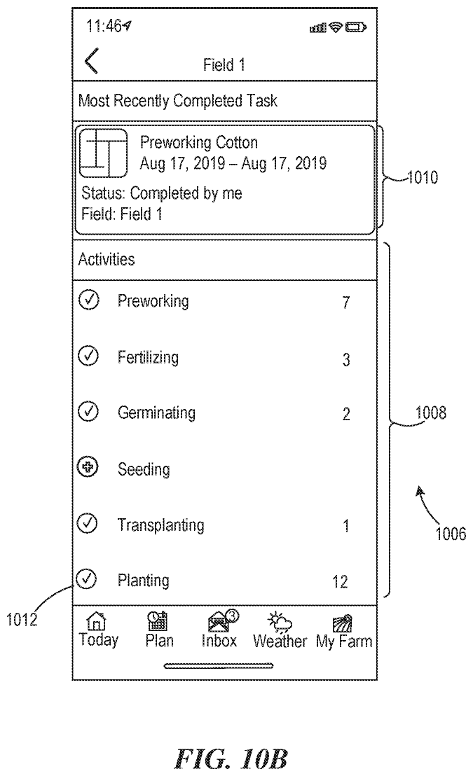

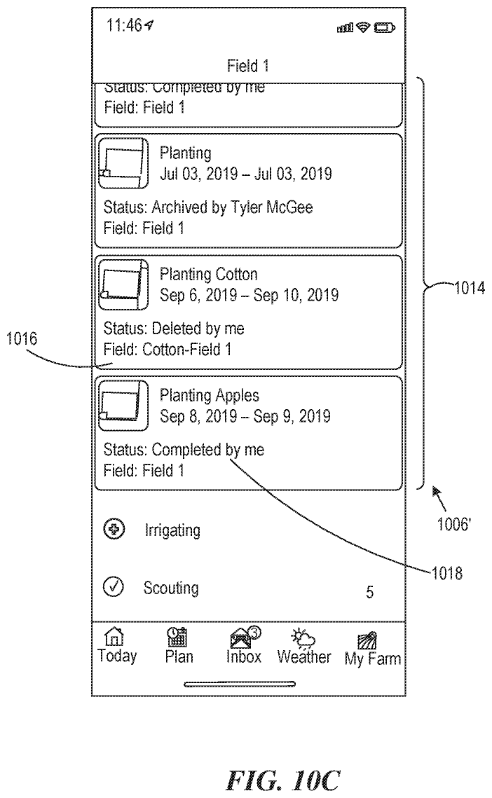

For an overview of the status of the farm and associated farming tasks, the backend system 210 may maintain the task management data in a given organizational arrangement for a particular farm 102. As shown in FIG. 2B, the backend system 210 may maintain a plan 222 as a top level category. Within the plan 222, in some embodiments various years 224 of managing the farm 102 are arranged. For the plan 222, and for a given year 224 when present as an arrangement level, a farm field representation 226 for each field 108 in the farm 102 is established. For each farm field representation 226, an activity type 228 for tasks is established where the activity type is the type of work to be done to complete the task. For each activity type 228, a collection of existing task objects 230 are present that represent each of the tasks that has been created for the farm 102. This arrangement is discussed in more detail below with reference to FIGS. 10A-10C following the discussion of creating and completing tasks.

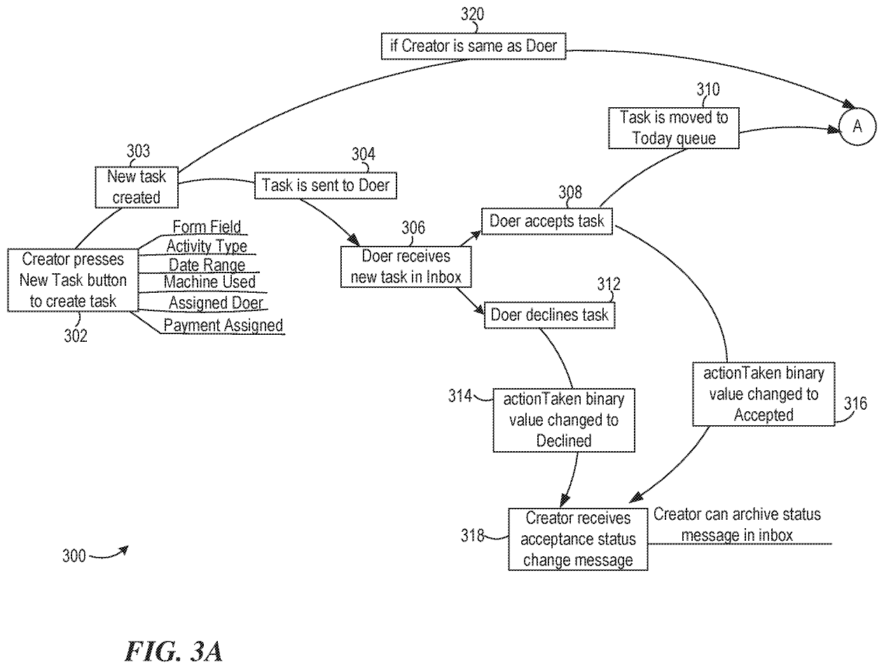

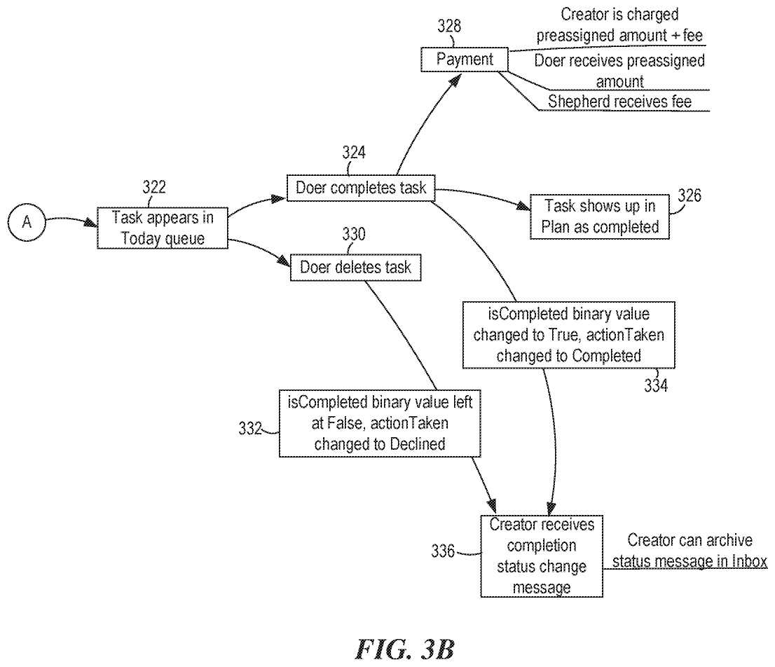

The data structure of a given task object 230 is shown in FIG. 2C. As can be seen, the task object 230 is created with attributes that are associatively linked together in a flat, non-hierarchical data structure where each attribute has equal prominence. These attributes of this example include: a farm field attribute 232, an activity category attribute 234, an assigned doer attribute 236, a machine attribute 238, start/end date attribute 240, payment attribute 242, and questions attribute 246. A notes attribute 244 may also be included and in this example is a sub-attribute o the questions attribute 246. Within each attribute, there are attribute values that have been received from the task creator during the task creation process of FIGS. 3A-5J occurring within the system 200. While task objects 230 are created and maintained by the backend system 210 in this example, it will be appreciated that other manners of associating task related attributes is also possible in order to provide the farm management services.

The farm field attribute 232 may be further organized by crop as will be further discussed below. The farm field attribute 232 is also related to the weather forecast that is relevant to the geographical location associated with each farm field option that may be chosen. The farm field attribute also allows for organization of information on a field by field basis within the farm plan 222.

The activity category attribute 234 may be used not only to indicate the type of activity that is needed but also provides context for additional information that may be collected. As discussed below, a task detail card of a user interface request additional information specific to the activity category that is chosen.

The doer attribute 236 which assigns the worker to the task represented by the task object 230 is based on doer accounts within the backend system 210 that are members of the account for the particular account of the backend system 210 for the specific farm 102. This allows for accountability tracking of the doer relative to assigned tasks on the farm 102 and also provides the relevant doer options for selection during task creation and for task notification routing to the account of the assigned doer. The specific doer may be assigned by the task creator, or the specific doer may be assigned by a doer within a pool of workers for the farm 102 accepting a task that has been assigned to the pool of workers.

The machine attribute 238 allows for the backend system 210 to monitor the amount of machine usage and thereby schedule maintenance for a particular machine based on the tracked usage. The backend system 210 may also employ scheduling conflict avoidance where if a machine is already associated to a task object having a given date for the activity to take place, another task object is not able to select that machine for a task for the same date. This machine attribute 238 also allows the backend system to automatically dispatch the machine to the given field at the appropriate date for a farm 102 with a dispatch capability.

The date attribute 240 allows the backend system 210 to keep track of when a task becomes overdue and provide related notifications to task creators and/or assigned doers. The date attribute 240 may also be used by the backend system 210 for chronologically ordering task objects within displayed lists.

The payment attribute 242, for scenarios that include it, allows the backend system 210 to implement payment to the doer upon the task being marked as completed. The payment attribute 242 tracks the amount to pay as set by the task creator. This payment attribute 242 therefore also allows for record keeping of labor costs for the farm.

The follow-up questions attribute 246 keeps track of task details that the task creator and/or doer may enter into the user interface to associate to the task object 230 maintained by the backend system 210. The information that is included may be viewed by those interested in the task in order to observe additional details that are more specific than the activity type. As discussed above, the notes attribute 244 may be a sub-attribute of the follow-up questions attribute 246 to allow further information, such as any post-task information the doer may wish to add to the record.

An additional attribute for the task object 230 is also provided as status attribute 231. The value for this attribute is not established during task creation but is instead set by the backend system 210 during subsequent handling of the task object. As described below, when a task is assigned and provided to a doer, the doer may accept or decline the task and this status is captured by the status attribute 231 and used by the backend system 210 when notifying relevant parties as to the acceptance status of the task. As also described below, when a task is later declined after having been previously accepted or when the task is completed, this status is captured by the status attribute 231 and also used by the backend system 210 when notifying relevant parties as to the completion status of the task.

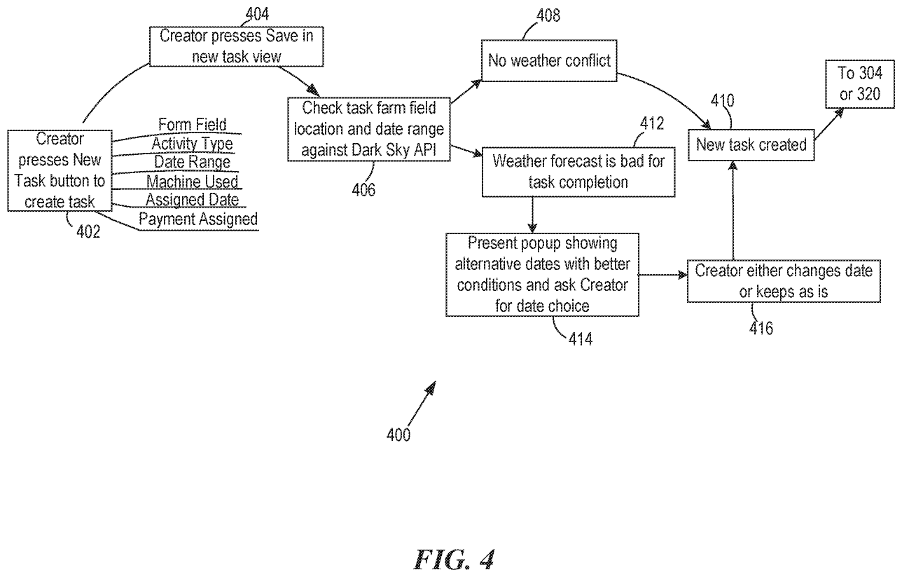

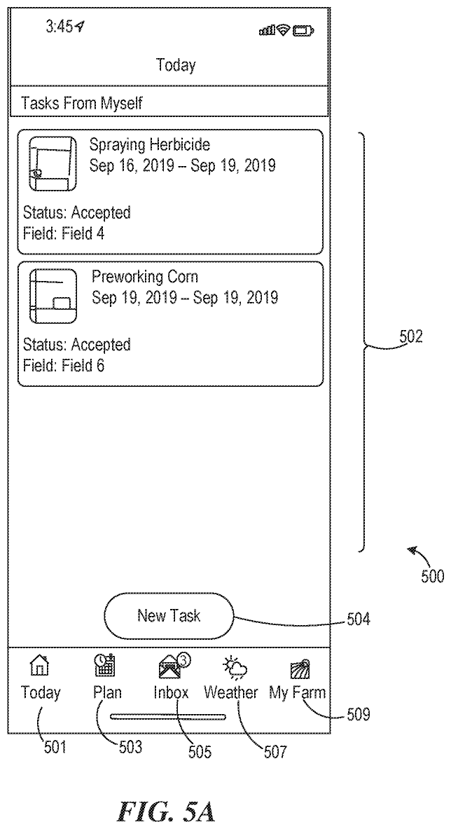

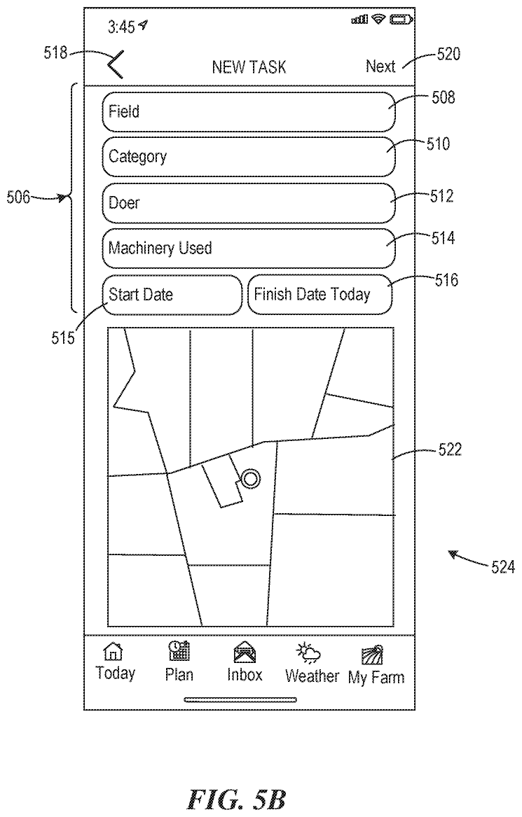

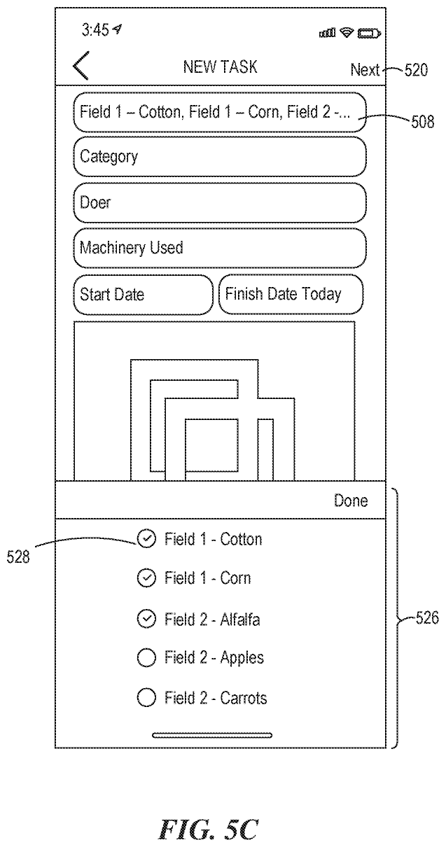

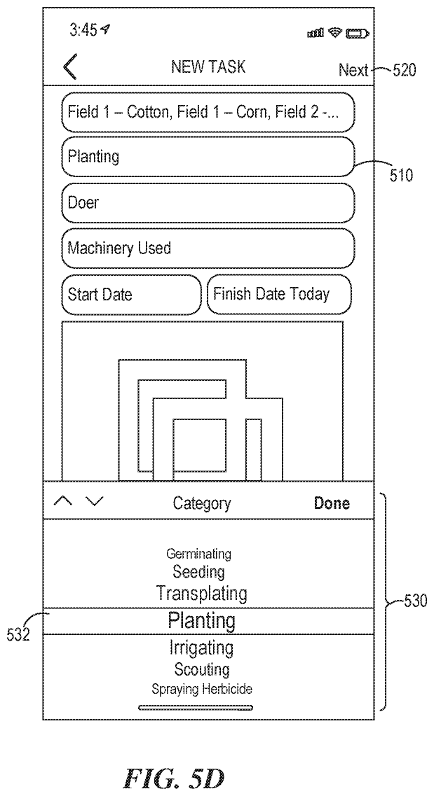

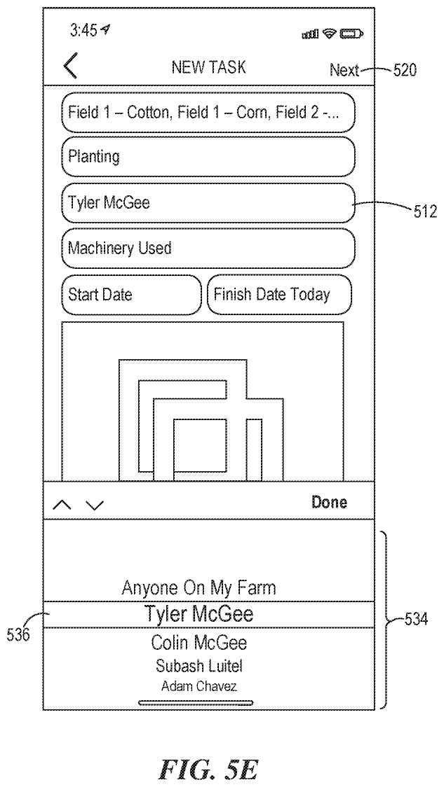

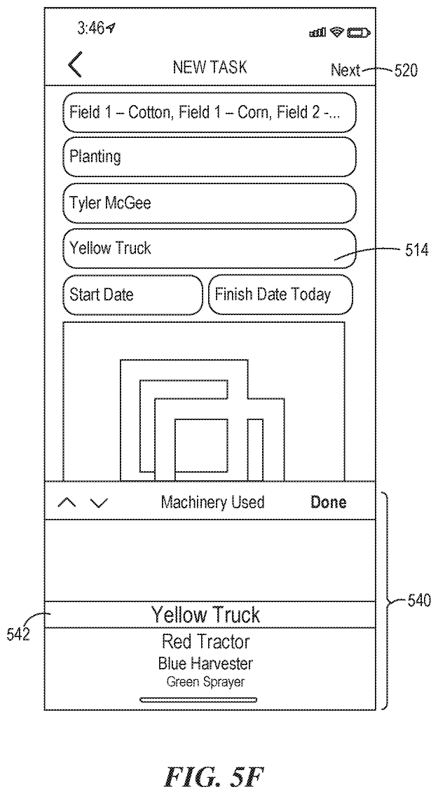

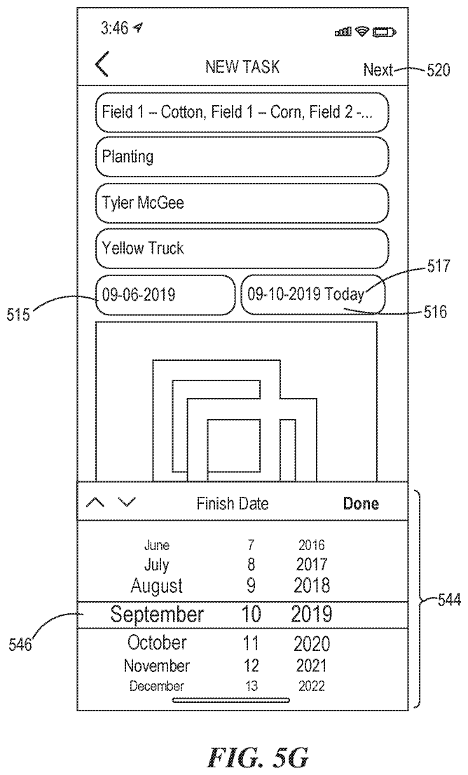

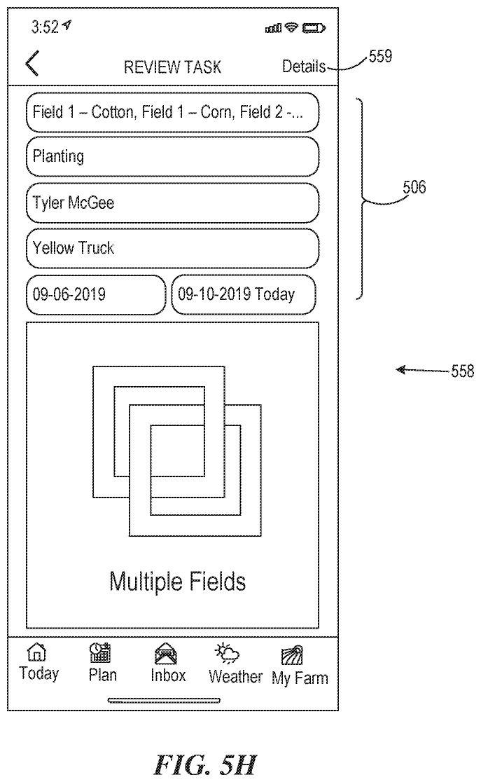

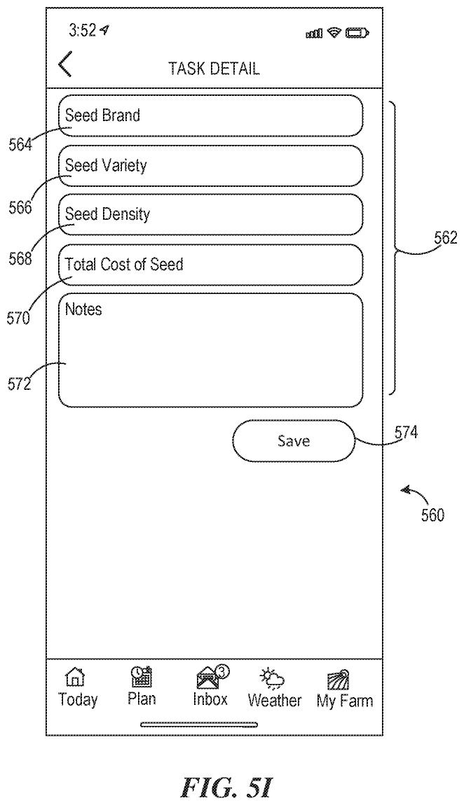

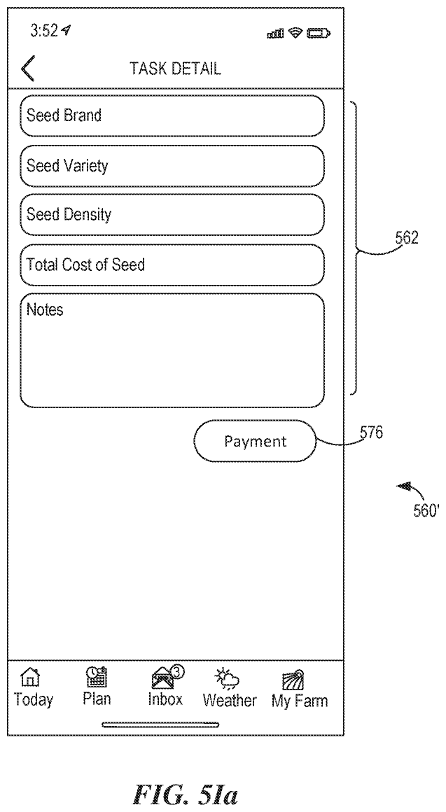

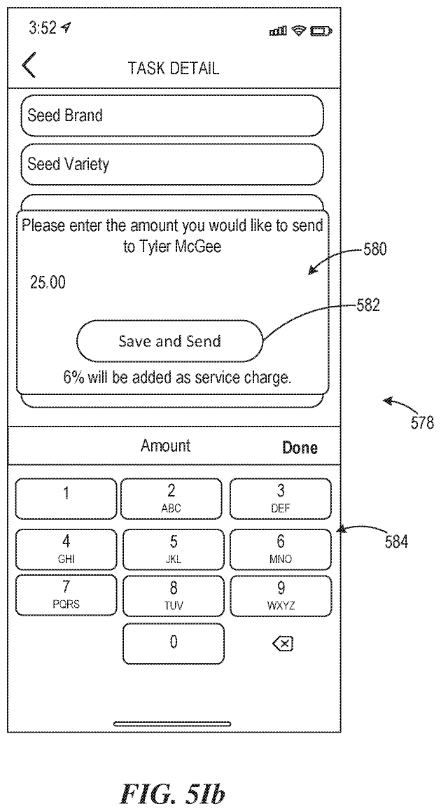

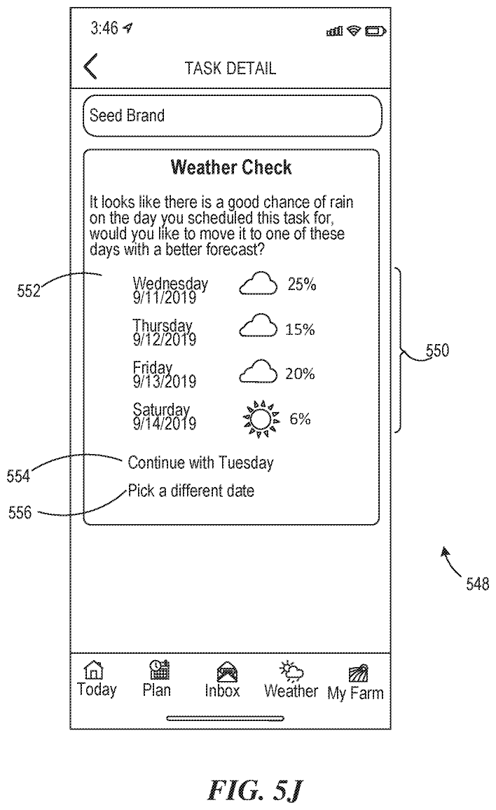

FIGS. 3A and 3B show an example of an operational flow 300 of the system 200 to create and complete a task object. FIG. 4 shows an example of an alternate operational flow that applies weather forecast logic to assist in selecting start and/or end date attributes for the task object. FIGS. 5A-9 provide the sequence of graphical user interface screens of the device of the task create and the device of the assigned doer for the operational flow of FIGS. 3A, 3B, and 4.

The operational flow 300 of FIG. 3A and 400 of FIG. 4 begins where a user device 204, 206 of a task creator displays a today card 500 as shown in a screenshot of FIG. 5A that includes various user interface items such as a set of existing tasks 502, today button 501, plan button 503, inbox button 505, weather button 507, my farm button 509, and a new task button 504. Prior to creating new tasks, an administrator of the farm 102 such as the owner or other management personnel may select the my farm button 509 to perform administrative tasks including creating available assets for each attribute of a task. For instance, within the My Farm section accessed via the my farm button 509, the administrator may assign fields to the farm, assign crops to the fields, assign activity types to the fields, assign doers to the farm, and assign machinery to the farm.

Once available assets are created for each attribute, a task creator may then create a new task. The task creator selects the new task button 504 to begin the operational flow of creating the new task at operation 302, 402. This new task button 504 then causes the system 200 to begin accepting data for attributes of the new task at the operation 302, 402. In the example shown in FIGS. 5A-5J, the user device 204, 206 via the on-board application or via a web browser displays a series of cards, each with data input fields where the task creator provides the attribute information for the task object 230.

In the example shown, after the task button 504 is selected, a new task card 524 is displayed as shown in FIG. 5B. This new task card 524 includes navigational features such as a back button 518 that returns to the today page to exit the new task creation and a next button 520 that moves to a next card in the task creation process once the task creator is finished inputting attribute information. The new task card 524 includes a set of data input fields 506 for receiving the attribute information from the task creator. There is a farm field input field 508, an activity category input field 510, a doer input field 512, a machinery input field 514, and date range input fields including a start date field 515 and an end date field 516 in this example. It will be appreciated that other data input fields can be included if more attributes for the task object 230 are desired. In the example of FIG. 5B, there is also a satellite view of the farm.

As shown in FIG. 5C, when the task creator selects the farm field data input field 508, selectable farm field assets for the attribute are displayed in a list 526 where each asset 528 within the list can be selected by the task creator. To reduce the data input burden on the task creator when desiring to create multiple tasks for a doer that involve the same activity, machinery, and/or date range, the farm field input 508 may allow multiple fields to be selected. In this example, the task creator has selected two different fields, Field 1 and Field 2 for the locations where the task should be performed. Additionally, multiple crops may be planted in separate portions of a same field, and in that case, the options 528 may the different crop sections for each field as being the option for selection. In the example shown, Field 1 has a cotton section and a corn section, and the task creator has selected both sections in order to create two tasks for the doer. As shown, Field 2 includes three crop sections but the task creator has only chosen the Alfalfa section for purposes of creating a new task.

As shown in FIG. 5D, when the task creator selects the activity category data input field 510, selectable activity assets for the attribute are displayed in a list 530 where each asset 532 within the list can be selected by the task creator. Any number of activity categories may be presented. In one example, the activity categories include: 1) Preworking, 2) Fertilizing, 3) Germinating, 4) Seeding, 5) Transplanting, 6) Planting, 7) Irrigating, 8) Scouting, 9) Spraying Herbicide, 10) Spraying Insecticide, 11) Spraying Pesticide, 12) Spraying Fungicide, 13) Summer Fallowing, 14) Harvesting, 15) Crop Out, 16) Drying, 17) Transporting, 18) Selling, and 19) Storing. In this example, the task creator has selected Planting as the activity to be performed to complete the task.

As shown in FIG. 5E, when the task creator selects the doer data input field 512, selectable doer assets for the attribute are displayed in a list 534 where each asset 536 within the list can be selected by the task creator. An individual doer may be selected by name from the list which then allows this doer to be notified of the task and given an opportunity to accept the task. Alternatively, a pool option that includes a pool of workers for the farm may be selected by choosing the Anyone on My Farm option which then allows the entire set of doers for the farm to be notified of the task and given an opportunity to accept the task, whereupon the backend system 210 then associates that doer with the task object 230. In this example, the task creator has selected Tyler Mcgee as the doer who is responsible for completing the task.

As shown in FIG. 5F, when the task creator selects the machinery data input field 514, selectable machine assets for the attribute are displayed in a list 540 where each asset 542 within the list can be selected by the task creator. In this example, the task operator has selected the yellow truck as the machine to be used to complete the task.

As shown in FIG. 5G, when the task creator selects the date range fields including start date field 515 and end date field 516, selectable date assets for the attribute are displayed in a list 544 where each date asset 546 within the list 544 can be selected by the task creator as the start date or end date and thereby specify the date range for the task. In this example, the task operator has selected the start date as Sep. 6, 2019 and is selecting Sep. 10, 2019 as the end date, thereby creating a five day range for completing the planting tasks in Fields 1 and 2. Start date field 515 and/or end date field 516 also includes a Today button 517 that allows a user to quickly set the start date or end date for performing the task as today.

Once the task creator has finished making the attribute selections of FIGS. 5B-5G, the task creator may then select the next button 520. In this example, the next card that is displayed is a review task card 558 as shown in FIG. 5H. Here, the task creator can review all of the attribute data input fields 506 for accuracy and then select a details button 559 to proceed.

Upon proceeding, a task detail card 560 is displayed. Here, the task creator may enter information that in sub-attributes of the selected activity category via data input fields 562. These sub-attributes correspond to the follow-up questions 246 of FIG. 2C. In this scenario where Planting has been selected as the activity type, the data input fields 562 include a seed brand field 564, seed variety field 566, seed density field 568, and total cost of see field 570. A notes field 572, corresponding to the sub-attribute notes 244 of FIG. 2C, allows additional information to be provided by the task creator but may also receive additional information from the doer when completing the task, as discussed in more detail below. Upon entering this additional information, the task creator then selects a save button 574 to save the new task. In the example of FIG. 3A, the new task object is then fully created at the backend system 210 at an operation 303.

FIG. 5Ia shows an alternative to FIG. 5I in a scenario where creating the new task involves attaching payment information to the task object 230. In this case, the save button 574 of the task detail card 560 of FIG. 5I is replaced with a payment button 576 of a task detail card 560′ of FIG. 5Ia. Upon selecting the payment button 576, a pop-up 578 is displayed as in FIG. 5Ib that includes a section 580 that explains details of the payment such as the recipient, payment amount that has been entered, service charge, and a save button 582. A portion 584 provides a number pad for entering the payment amount. Upon entering this payment information, the task creator then selects a save button 582 to save the new task. In the example of FIG. 3A, the new task object 230 is then fully created at the backend system 210 at the operation 303.

In the example of FIG. 4, when either the save button 574 or the save button 582 are selected by the task user at state 404, additional operations are performed that are not included in FIG. 3A. Namely, the backend system 210 performs a look-up of the location of the selected farm field and the selected date within a weather forecast database that specifies a percent chance of one or more weather conditions, such as via the Dark Sky weather service application programming interface (API), at an operation 406. If there is no weather condition prediction that presents a conflict for the farming activity, such as if there is a low chance of rain, wind, lightning, and the like that does not exceed a threshold, as indicated at state 408, then the new task object 230 is created with the existing date range selection at an operation 410. For example, if the predicted chance of all adverse weather conditions is less than a threshold of 50%, then the backend system 210 proceeds with the existing date range.

Returning to operation 406, if there is a weather condition prediction that presents as conflict as indicated at state 412 due to the weather condition prediction from the weather forecast database exceeding a threshold, then the backend system 210 obtains a collection of days that follow the selected date range for the task at an operation 414. These days that are obtained by the backend system 210 from the weather forecast database may be those that present no weather condition conflict. Here, a popup 548 as shown in FIG. 5J may be displayed for the task creator to offer a list 550 of these alternative days for the task. Each alternative option 552 of the list 550 may specify the day and the forecast, such as providing a percent chance of rain and/or other weather variables. The selected date, if any, from the list 550 may be used as a new end date for the date range so as to provide a date range with these alternate days. The task creator may instead select an option 554 to proceed with the originally selected date range or select an option 556 to pick an entirely different date than the alternatives of the list 550. Once the task creator makes the choice at operation 416, then the new task object 230 is created with the existing date range selection at an operation 410.

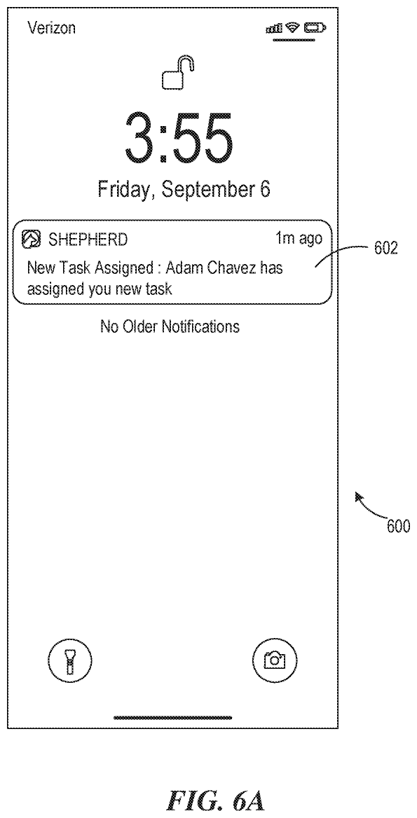

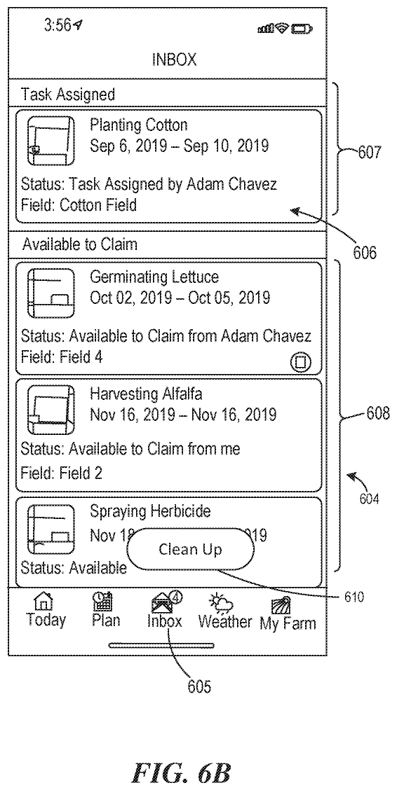

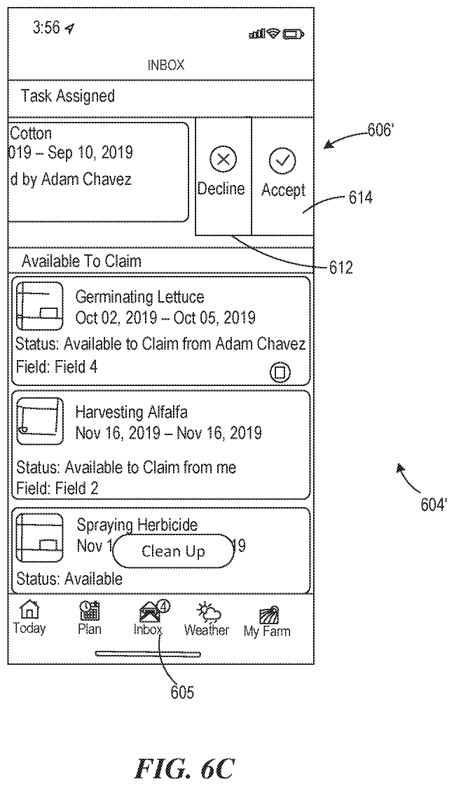

Returning to FIG. 3A, once the new task object 230 is created, the next operations depend upon whether the doer is the task creator or someone else. If the selected doer that has been selected is the task creator as at state 320, then operational flow proceeds to an operation 322 of FIG. 3B discussed in more detail below. If the selected doer is someone else as at state 304, then the backend system 210 provides the task object 230 to an inbox of the selected doer at an operation 306 which may trigger a notification 602 on the device lock screen 600 of the selected doer as shown in FIG. 6A.

Upon the selected doer checking the inbox card 604 via selecting the inbox button 604 as shown in FIG. 6B, the new task object 230 is displayed as a selectable item 606 that falls within a section 607 of the inbox that displays items corresponding to task objects that have been assigned to the doer. The inbox card 604 also includes a section 608 that displays items corresponding to task objects that have been assigned to all doers for the farm and are available for this doer to claim by accepting. The inbox also includes a clean up button 610 which allows status items within the inbox that do not require further interaction to be archived and thereby de-clutter the inbox. As shown in FIG. 6C, the doer may select the item 606′, such as by swiping to the left, to reveal options to accept 614 or decline 612 the task.

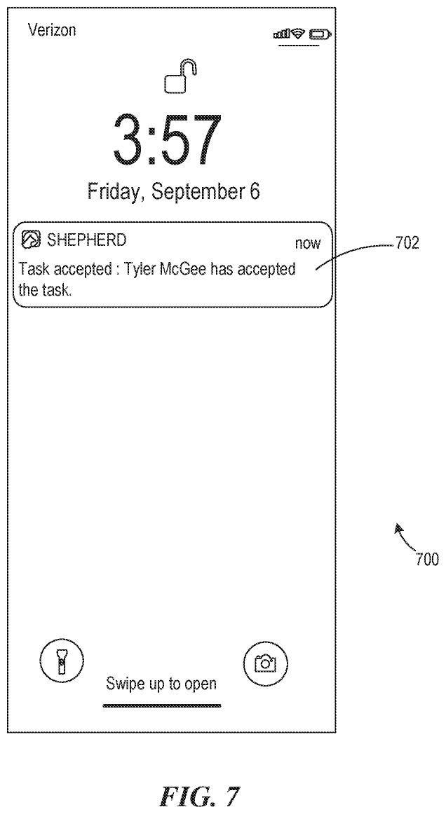

When the doer accepts the task as shown at state 308, the task is moved to the today queue of the doer at an operation 310 in preparation for the doer viewing the task in the today queue at the operation 322 of FIG. 3B. Additionally, the backend system 210 reflects the acceptance within an accept/decline attribute of the task object at an operation 316. This may simply be a binary value. At this time, the backend system 210 may send the task creator a message indicating the acceptance of the task at an operation 318, and this may include providing a notification 702 on a lock screen 700 of the task creator's device as shown in FIG. 7.

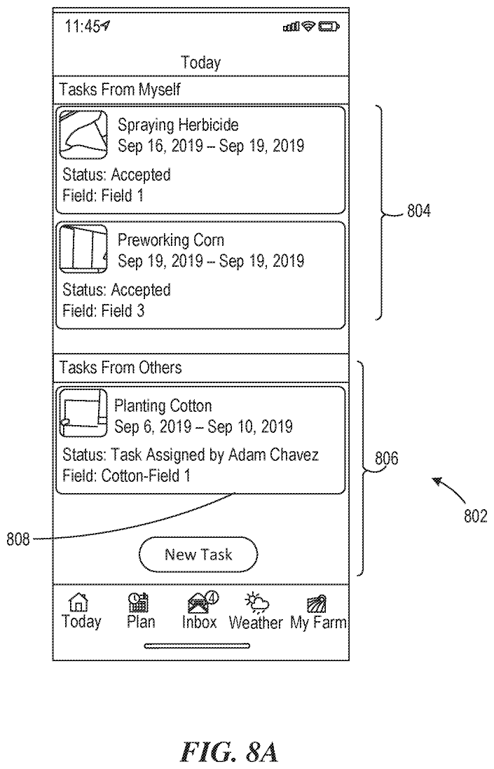

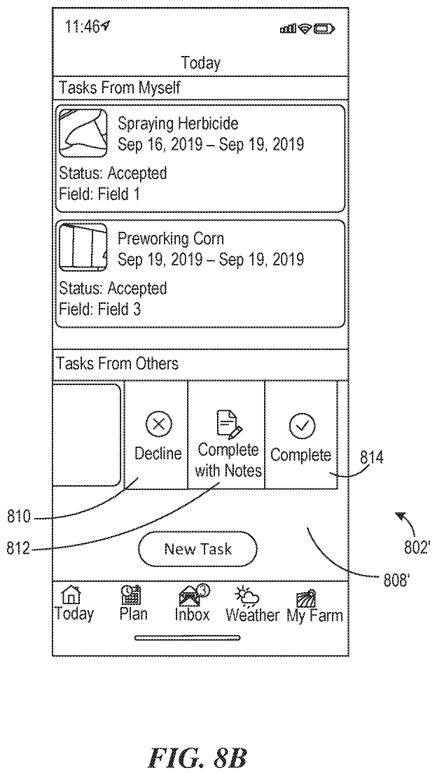

According to operation 322 of FIG. 3B and as shown in FIG. 8A, the new task object is included as an item 808 within a list 806 of tasks from others in the today queue 802 of the doer's account on the doer's device 218. The today queue 802 also includes a list 804 of tasks that the doer has assigned to himself Once the doer has either completed the task or recognized that the doer needs to decline the task, the doer may then interact with the item 808′ within the today view 802′ of FIG. 8B by swiping left to reveal various options for the item 808′. A decline option 810 is selected to decline the task, a first complete option 814 is selected to indicate that the task has been completed, and a second complete option 812 is selected to indicate that the task has been completed and to add notes to the task object for previously mentioned notes attribute 244.

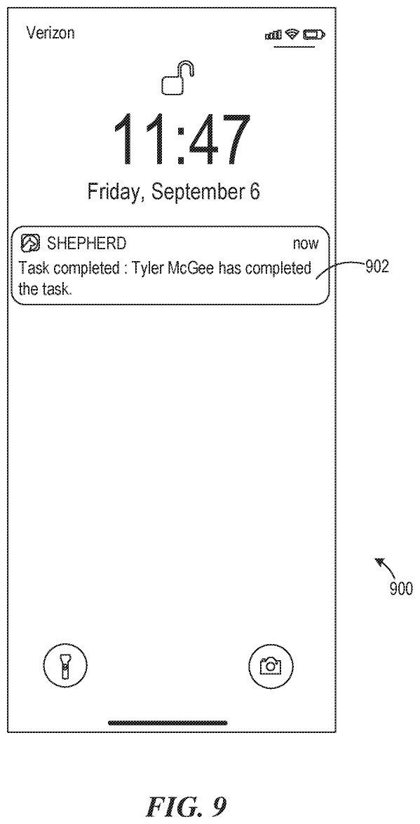

When the doer selects that the task has been completed via option 812 or option 814, setting state 324, then the backend system 210 sets the status for the task object 230 to completed at operation 334. Then, a status message may be provided to the task creator, such as a notification 902 on the lock screen 900 of the device of the task creator as shown in FIG. 9. Additionally, the task object is marked as a completed task within the plan 222 for the farm 102 at operation 326.

For either the task creator or the doer or anyone else given permission via association with the farm in the system, the plan may be reviewed by selecting the plan button 503 to display the plan card 1000 in FIG. 10A. The plan card 1000 includes a list 1002 of individual field options 1004 that the user may select. Upon selecting a field, field 1 in this example, then a list 1008 of activities 1012 for that field are shown within a plan card 1006 of FIG. 10B. Plan card 1006 also includes a list 1010 of recently completed tasks for this selected field. Upon selecting an activity 1012, then plan card 1006′ expands that activity to display a list 1014 of all of the task object items 1016 that involve that selected activity for the selected field in FIG. 10C. Each task object item includes a current status attribute 1018 that is displayed for the user to observe. In this manner, the user can obtain an overview of what has been done and what has not for a given activity type and field. By reviewing across all activity types for a given field, and then across all fields for the farm 102, the user can obtain a farm-level understanding of the status of tasks being performed. This record keeping within the plan is provided by extracting the context from the tasks themselves, such as the field and then activity type, that allows for sorting, instead of requiring any separate action from the user to piece together this information. Thus, this function within the plan provides the ability to pull the important meaning out of tasks as the tasks happen and file these meaningful details for inspection when viewing the plan details via the plan button 503.

Returning to the operation 322 displaying the task object within the today queue of the doer, when the doer selects that the task is being declined via decline option 810, setting state 330, then the backend system 210 sets the status for the task object 230 to declined at operation 332. Then, a status message may be provided to the task creator, such as a notification similar to notification 902 of FIG. 9.

Returning to state 324 where the doer has indicated that the task is completed, additional operations may occur for the scenario where payment information was attached to the task object 230 back in operation 302, 402. In particular, at operation 328, the payment information is implemented to initiate a payment to the doer. This may involve the backend system 210 interacting with an electronic payment service such as Stripe over a network connection to initiate an electronic payment. In that case, the farm account is charged while transferring the funds specified by the task object 230 for the completed task to the doer account. Both the payment service and the farm management service providing the backend system 210 may also receive fees appropriate for the transaction which are charged against the farm account at the payment processing service, and the farm management service fee is then provided by the payment processing service to the farm management service account established with the payment processing service.

While embodiments have been particularly shown and described, it will be understood by those skilled in the art that various other changes in the form and details may be made therein without departing from the spirit and scope of the invention.

What is claimed is:

1. A method of assigning tasks to a farming workforce, comprising:
providing a user interface with a set of attribute input interface fields that comprise a farm field interface field, an activity type interface field, and a doer interface field;
providing farm field assets for selection for the farm field interface field;
providing activity type assets for selection for the activity type interface field;
providing doer assets for selection for the doer interface field;
receiving into the farm field interface field a farm field asset selection from the farm field assets;
receiving into the activity type interface field an activity type asset selection from the activity type assets;
receiving into the doer interface field a doer asset selection from the doer assets;
creating an association of the received farm field asset selection, the received activity type asset selection, and the received doer asset selection, the association having a completion state value that represents that a task represented by the association has been completed or deleted;
providing a message regarding the task to an account of the doer asset selection, the message indicating the received farm field asset selection and received activity type asset selection;
receiving from the account of the doer asset an indication regarding the task, the indication specifying that the task has been completed or deleted; and
changing the completion state value to represent that the task has been completed or deleted.

2. The method of claim 1, wherein creating the association of the received farm field asset selection, the received activity type asset selection, and the received doer asset selection with the association having the completion state value that represents that the task represented by the association has been completed or deleted comprises creating a task object where the received farm field asset selection, the received activity type asset selection, the received doer asset selection, and the completion state value are linked to the task object.

3. The method of claim 1, wherein providing doer assets for selection for the doer interface field comprises providing a pool option, wherein receiving into the doer interface field a doer asset selection from the doer assets comprises receiving selection of the pool option, wherein providing a message regarding the task to an account of the doer asset selection comprises providing the message regarding the task to an account of each doer asset associated with the pool option, and wherein the method further comprises receiving from an account of one of the doer assets associated with the pool option an acceptance of the task and wherein creating the association further comprises creating an association of the doer asset to the association of the received farm field asset selection and the received activity type asset selection.

4. The method of claim 1, wherein providing the user interface with a set of attribute input interface fields further comprises providing the user interface with a payment interface field, the method further comprising receiving into the payment interface field a payment amount, and wherein creating the association comprises including the payment amount in the association, the method further comprising upon receiving from the account of the doer asset the indication specifying that the task has been completed or deleted, when the indication specifies that the task has been completed then initiating an electronic payment of the payment amount to a payment account of the doer asset.

5. The method of claim 1, further comprising:
providing date assets for selection for the date interface field and receiving into the date interface field a date asset selection from the date assets; and
creating an association of the date asset selection to the association of the received farm field asset selection and the received activity type asset selection.

6. The method of claim 5, further comprising:
performing a look-up of the date asset in a weather forecast database;
when the weather forecast database shows a weather condition prediction that exceeds a threshold for the date asset, then providing an indication within the user interface about the weather condition prediction for the data asset and providing an alternate date asset for selection that has a weather condition prediction within the weather forecast database that does not exceed the threshold; and
when the alternate date asset is selected, then replacing the date asset selection with the alternate date asset selection within the association.

7. The method of claim 1, wherein creating the association comprises creating a task object and by providing associative linking of the received farm field asset selection, the received activity type asset selection, and the received doer asset selection, the task object thereby providing a data model that is a flat non-hierarchy of the received farm field asset selection, the received activity type asset selection, and the received doer asset selection to avoid hierarchy.

8. The method of claim 1, wherein providing the message regarding the task to the account of the doer asset selection comprises providing an option to accept or decline the task, the method further comprising receiving a selection of the option to accept or receiving a selection of the option to decline, when receiving the selection of the option to accept, then maintaining the doer asset selection within the association, and when receiving the selection of the option to decline, then providing a message to the user interface that the task has been declined and removing the doer asset selection from the association.

9. The method of claim 1, wherein providing the user interface with a set of attribute input interface fields further comprises providing the user interface with a machine interface field, the method further comprising:
providing machine assets for selection for the machine interface field; and
receiving into the machine interface field a machine asset selection from the machine assets, and wherein creating the association comprises including the machine asset selection in the association.

10. A method of assigning tasks to a farming workforce, comprising:
providing a user interface with a set of attribute input interface fields that comprise a farm field interface field, an activity type interface field, a doer interface field, and a date interface field;
providing farm field assets for selection for the farm field interface field;
providing activity type assets for selection for the activity type interface field;
providing doer assets for selection for the doer interface field;
providing date assets for selection for the date interface field;
receiving into the farm field interface field a farm field asset selection from the farm field assets;
receiving into the activity type interface field an activity type asset selection from the activity type assets;
receiving into the doer interface field a doer asset selection from the doer assets;
receiving into the date interface field a date asset selection from the date assets;
creating an association of the received farm field asset selection, the received activity type asset selection, the received doer asset selection, and the received date asset selection;
performing a look-up of the date asset in a weather forecast database;
when the weather forecast database shows a weather condition prediction that exceeds a threshold for the date asset, then providing an indication within the user interface about the weather condition prediction for the data asset and providing an alternate date asset for selection that has a weather condition prediction within the weather forecast database that does not exceed the threshold;
when the alternate date asset is selected, then replacing the date asset selection with the alternate date asset selection within the association; and
providing a message regarding the task to an account of the doer asset selection, the message indicating the received farm field asset selection, the received activity type asset selection, and the received data asset selection or the alternate date asset selection.

11. The method of claim 10, wherein creating the association of the received farm field asset selection, the received activity type asset selection, and the received doer asset selection with the association having the completion state value that represents that the task represented by the association has been completed or deleted comprises creating a task object where the received farm field asset selection, the received activity type asset selection, the received doer asset selection, and the completion state value are linked to the task object.

12. The method of claim 10, wherein providing doer assets for selection for the doer interface field comprises providing a pool option, wherein receiving into the doer interface field a doer asset selection from the doer assets comprises receiving selection of the pool option, wherein providing a message regarding the task to an account of the doer asset selection comprises providing the message regarding the task to an account of each doer asset associated with the pool option, and wherein the method further comprises receiving from an account of one of the doer assets associated with the pool option an acceptance of the task and wherein creating the association further comprises creating an association of the doer asset to the association of the received farm field asset selection and the received activity type asset selection.

13. The method of claim 10, further comprising upon receiving from the account of the doer asset the indication specifying that the task has been completed or deleted, when the indication specifies that the task has been completed then initiating an electronic payment to a payment account of the doer asset.

14. The method of claim 10, wherein creating the association comprises creating a task object and by providing associative linking of the received farm field asset selection, the received activity type asset selection, and the received doer asset selection, the task object thereby providing a data model that is a flat non-hierarchy of the received farm field asset selection, the received activity type asset selection, and the received doer asset selection to avoid hierarchy.

15. The method of claim 10, wherein the association includes a completion state value that represents that a task represented by the association has been completed or deleted, and wherein the method further comprises:
receiving from the account of the doer asset an indication regarding the task, the indication specifying that the task has been completed or deleted; and
changing the completion state value to represent that the task has been completed or deleted.

16. A method of assigning tasks to a farming workforce, comprising:
providing a user interface with a set of attribute input interface fields that comprise a farm field interface field, an activity type interface field, and a doer interface field;
providing farm field assets for selection for the farm field interface field;
providing activity type assets for selection for the activity type interface field;
providing doer assets for selection for the doer interface field;
receiving into the farm field interface field a farm field asset selection from the farm field assets;
receiving into the activity type interface field an activity type asset selection from the activity type assets;
receiving into the doer interface field a doer asset selection from the doer assets;
creating a task object by providing associative linking of the received farm field asset selection, the received activity type asset selection, and the received doer asset selection, the task object thereby providing a data model that is a flat non-hierarchy of the received farm field asset selection, the received activity type asset selection, and the received doer asset selection to avoid hierarchy; and
providing a message regarding the task object to an account of the doer asset selection, the message indicating the received farm field asset selection and received activity type asset selection.

17. The method of claim 16, wherein providing doer assets for selection for the doer interface field comprises providing a pool option, wherein receiving into the doer interface field a doer asset selection from the doer assets comprises receiving selection of the pool option, wherein providing a message regarding the task to an account of the doer asset selection comprises providing the message regarding the task to an account of each doer asset associated with the pool option, and wherein the method further comprises receiving from an account of one of the doer assets associated with the pool option an acceptance of the task and wherein creating the association further comprises creating an association of the doer asset to the association of the received farm field asset selection and the received activity type asset selection.

18. The method of claim 16, further comprising upon receiving from the account of the doer asset the indication specifying that the task has been completed or deleted, when the indication specifies that the task has been completed then initiating an electronic payment to a payment account of the doer asset.

19. The method of claim 16, wherein the association includes a completion state value that represents that a task represented by the association has been completed or deleted, and wherein the method further comprises:
receiving from the account of the doer asset an indication regarding the task, the indication specifying that the task has been completed or deleted; and
changing the completion state value to represent that the task has been completed or deleted.

20. The method of claim 16, further comprising:
providing date assets for selection for the date interface field and receiving into the date interface field a date asset selection from the date assets;
providing an associative linking of the date asset selection to the task object;
performing a look-up of the date asset in a weather forecast database;
when the weather forecast database shows a weather condition prediction that exceeds a threshold for the date asset, then providing an indication within the user interface about the weather condition prediction for the data asset and providing at least one alternate date asset for selection that has a weather condition prediction within the weather forecast database that does not exceed the threshold; and
when one of the at least one alternate date assets is selected, then replacing the date asset selection with the alternate date asset selection within the associative linking to the task object.
